(19) United States
(12) Patent Application Publication
(10) Pub. No.: US 2026/0332011 A1
(43) Pub. Date: Oct. 22, 2026

(54) VIBRATION ACTUATOR COMPRISING PCB PLATE HAVING LEAD WIRE AND SUSPENSION INTEGRATED

(71) Applicant: ACTUWARD. CO. LTD., Suwon-si, Gyeonggi-do (KR)

(72) Inventor: Dong-Man KIM, Seoul (KR)

(73) Assignee: ACTUWARD. CO. LTD., Suwon-si, Gyeonggi-do (KR)

(21) Appl. No.: 19/122,794

(22) PCT Filed: Oct. 12, 2023
(86) PCT No.: PCT/KR2023/015686

§ 371 Date: Jul. 16, 2025

(30) Foreign Application Priority Data
Oct. 21, 2022 (KR) 10-2022-0136430

(51) Int. Cl. H02K 33/18

(52) U.S. Cl. CPC H02K 33/18

(57) ABSTRACT

The present invention relates to a vibration actuator, and more particularly, to a stick-type vibration actuator implemented to transmit vibration to a vibration target. The vibration actuator comprising a PCB plate having a lead wire and a suspension integrated according to the present invention comprises: a frame forming an outline; a pair of magnetic bodies spaced left and right and fixed to the inside of the frame; a coil plate including a coil disposed between the pair of magnetic bodies; a PCB plate located on the top of the coil plate; and a damper located at the bottom of the coil plate, wherein the PCB plate may be formed with a plurality of bridges having a suspension function and a lead wire for connecting to an external power source.

### TECHNICAL FIELD

The present invention relates to a vibration actuator, and more particularly, to a stick-type vibration actuator implemented to transmit vibration to a vibration target.

### BACKGROUND ART

A vibration driver refers to a device for transmitting vibration to a vibration target.

Typically, the vibration driver that is manufactured by removing a vibration plate from a so-called cone-type speaker device and directly attaching one of a circular magnet and a circular voice coil to the vibration target has been used.

The cone-type vibration driver has a disadvantage in that the cone-type vibration driver is required to be attached to a flat surface in order to bond an elliptical bobbin. Also, when the vibration driver has a large unit size, the cone-type vibration driver is difficult to efficiently transmit vibration energy and increases in weight because a circular magnetic body increases in size to maintain the circular structure. Furthermore, since the bobbin has a weak bonding strength relative to a weight thereof, it is difficult to attach the bobbin to the vibration target for long-term use.

Korean Patent Registration No. 10-1469555 discloses a “vibration speaker” that is attached to an artificial structure and simultaneously transmits sound and vibration.

Although the vibration speaker includes a plate-shaped mastoid that transmits sound or vibration to the artificial structure by using a magnetic body including a magnet and a voice coil, the vibration speaker has similar limitations to those of the above-described cone-type vibration driver in terms of the circular vibration structure.

Although the present applicant has developed and obtained Korean Patent Registration No. 10-2044846 titled “STICK TYPE VIBRATION DRIVER” and Korean Patent Registration No. 10-2186836 titled “FLAT TYPE VIBRATION DRIVER” to solve the above-described conventional limitations, since a trend toward miniaturization of electronic devices also demands miniaturization and slimness of the vibration device, the present applicant needs to actively respond to this demand.

### RELATED ART DOCUMENT

### [Patent Document]

(Patent document 1) Korean Patent Registration No. 10-1469555
(Patent document 2) Korean Patent Registration No. 10-2044846
(Patent document 3) Korean Patent Registration No. 10-2186836

### DISCLOSURE OF THE INVENTION

### Technical Problem

The present invention provides an ultra-slim vibration actuator having a haptic (tactile) function to actively respond to development of various haptic devices designed to implement a tactile sense such as haptic gloves as a demand for VR and METAVERSE technologies significantly increases.

Technical objects to be solved by the present invention are not limited to the aforementioned technical objects and unmentioned technical objects will be clearly understood by those skilled in the art to which the present invention belongs.

### Technical Solution

An embodiment of the present invention provides a vibration actuator with a lead wire and a suspension integrated, the vibration actuator including: a frame that forms an outer portion; a pair of magnetic bodies that is spaced apart from each other in left and right directions and fixed to the inside of the frame; a coil plate having a coil disposed between the pair of magnetic bodies; a PCB plate disposed at an upper end of the coil plate; and a damper disposed at a lower end of the coil plate, in which a plurality of bridges having a suspension function and a lead wire for connection to an external power supply are formed on the PCB plate.

In an embodiment, the PCB plate may include an edge, a central plate disposed at an inner center of the edge, and a plurality of bridges configured to connect the edge and the central plate.

In an embodiment, the PCB plate may include the lead wire having one end on which an external lead wire copper foil for soldering connection with an external lead wire is formed and the other end on which a coil plate copper foil for soldering connection with a coil of the coil plate is formed, a terminal block may be further formed at one end of the PCB plate, the external lead wire copper foil may be formed on the terminal block, and the coil plate copper foil may be formed on each of one end and the other end of the central plate.

In an embodiment, the coil plate copper foil may pass through the central plate and be formed on each of top and bottom surfaces of the central plate.

In an embodiment, the bridges may each have a shape having at least one curved portion and have the same number and the same shape on left and right sides based on the central plate.

In an embodiment, the PCB plate may include the lead wire having one end on which an external lead wire copper foil for soldering connection with an external lead wire is formed and the other end on which a coil plate copper foil for soldering connection with a coil of the coil plate.

In an embodiment, a terminal block may be further formed at one end of the PCB plate, the external lead wire copper foil may be formed on the terminal block, and the coil plate copper foil may be formed at a position corresponding to the coil plate disposed at a lower end of the PCB plate.

In an embodiment, each of both ends of the pair of magnetic bodies may be coupled to the guide, and the guide may be fastened to the frame by a bolt through a through-hole.

In an embodiment, a vent hole through which heat of the coil plate, which is generated by an operation of a magnetic circuit in the coil plate, is discharged to the outside may be formed in each of both side surfaces of the frame.

### Advantageous Effects

According to the above-described configuration of the present invention, the ultra-slim vibration actuator having the haptic (tactile) function may be provided to actively respond to various haptic devices designed to implement the tactile sense such as haptic gloves.

Also, the vibration actuator that is ultra-slim compared to the conventional vibration actuator may be provided by using the PCB plate with the lead wire and the suspension device integrated.

However, the effects of the present invention are not limited to the above-descried benefits and may be variously extended without departing from the spirit and scope of the invention.

### BRIEF DESCRIPTION OF THE DRAWINGS

FIG. 1 is a conceptual view illustrating a vibration actuator including a PCB plate with a lead wire and a suspension integrated according to the present invention.

FIG. 2 is a perspective view illustrating the vibration actuator including the PCB plate with the lead wire and the suspension integrated according to an embodiment of the present invention.

FIG. 3 is an exploded perspective view illustrating the vibration actuator including the PCB plate with the lead wire and the suspension integrated according to an embodiment of the present invention.

FIG. 4 is a cross-sectional view taken along line A-A in FIG. 2.

FIG. 5 is a cross-sectional view taken along line B-B in FIG. 2.

FIG. 6 is a perspective view illustrating the PCB plate of the vibration actuator including the PCB plate with the lead wire and the suspension integrated according to an embodiment of the present invention.

### MODE FOR CARRYING OUT THE INVENTION

Hereinafter, a structure and operation effects of a vibration actuator including a PCB plate with a lead wire and a suspension integrated according to the present invention will be described with reference to the accompanying drawings.

The detailed description on the specific embodiment illustrated in the accompanying drawings should be read in relation with the accompanying drawings, and the drawings are regarded as a part of the description of the entire invention. The terminology used herein is for the purpose of describing particular embodiments only and is not intended to be limiting of the invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are used for convenience of description and are not intended to limiting of the invention.

When it is described that an element is “coupled to”, “engaged with”, or “connected to” another element, it should be understood that the element may be directly coupled or connected to the other element but still another element may be “coupled to”, “engaged with”, or “connected to” the other element between them.

Note that the same or similar components in the drawings are designated by the same reference numerals as far as possible even if they are shown in different drawings. In the following description of the present invention, a detailed description of known functions and configurations incorporated herein will be omitted to avoid making the subject matter of the present invention unclear.

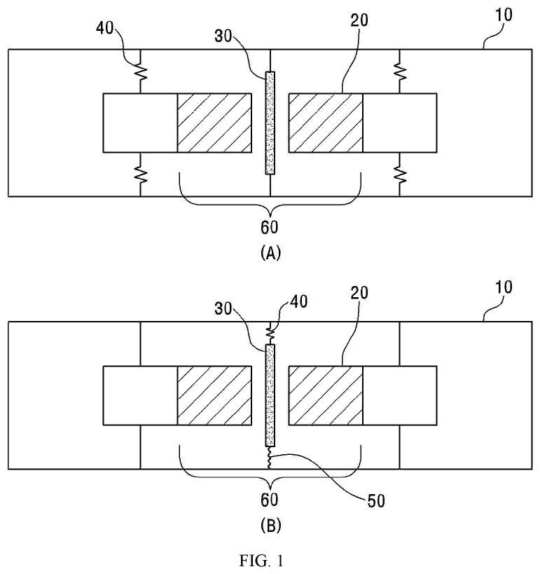

FIG. 1 is a conceptual view illustrating a vibration actuator including a PCB plate with a lead wire and a suspension integrated according to the present invention.

Referring to FIG. 1, (A) is a structural view illustrating a magnetic body 20 that vibrates vertically, and (B) is a structural view illustrating a coil plate 30 that vibrates vertically.

Referring to (A) of FIG. 1, a vibration driver may include an outer body 10, a magnetic body 20, a coil plate 30, and a suspension 40.

The outer body 10 may have a rectangular frame shape. The outer body 10 may be a stick-type long rectangular structure or may be attached to a vibration target.

The magnetic body 20 and the coil plate 30 may constitute a magnetic circuit unit 60.

An induced electromotive force is generated by the Fleming's left hand rule and the Lorentz force law depending on a configuration of a magnetic circuit of the magnetic circuit unit 60, and the magnetic body 20 vertically vibrates by the fixed coil plate 30.

The magnetic body 20 may be connected to the outer body 10 through the suspension 40 to vertically vibrate and transmit vibration to the vibrated target through the suspension 40.

Here, the vibration target may correspond to an object that requires a vibration effect according to a sound. For example, the vibration target may include a vibration chair for exhibiting a fourth-dimensional effect in a theater, an object that requires vibration in an experience center such as clothing or gloves related to a game in a fourth-dimensional game industry, and a wearable device having a fourth-dimensional vibration mechanism.

The magnetic circuit unit 60 includes a pair of magnetic bodies 20 that are spaced a predetermined distance from each other to face each other and a coil plate 30 disposed between the pair of magnetic bodies 20.

The pair of magnetic bodies 20, which face each other, may have the same configuration. That is, each of the magnetic bodies 20 may include a magnet and upper and lower magnetic plates (yokes) disposed on top and bottom surfaces of the magnet, respectively.

The magnets disposed in the magnetic bodies 20, which face each other, may have opposite polarities to act an attractive force therebetween, and the coil plate 30 may maintain the same distance from the magnetic bodies 20 disposed at both sides to receive the same magnetic force.

Here, the coil plate 30 has fixed upper and lower ends, and the fixed coil plate 30 forms a mechanism in which the both side magnetic bodies 20 vertically vibrate.

The magnetic body 20 may be connected to a base frame.

The coil plate 30 may be a printed circuit board (PCB) or a flexible printed circuit board (FPCB), in which a coil may be printed in a track pattern.

Referring to (B) of FIG. 1, the vibration driver may include an outer body 10, a magnetic body 20, a coil plate 30, and a suspension 40.

The outer body 10 may have a rectangular frame shape. The outer body 10 may be a stick-type long rectangular structure or may be attached to a vibration target.

The magnetic body 20 and the coil plate 30 may constitute a magnetic circuit unit 60.

An induced electromotive force is generated by the Fleming's left hand rule and the Lorentz force law depending on a configuration of a magnetic circuit of the magnetic circuit unit 60, and the coil plate 30 vertically vibrates by the fixed magnetic body 20.

The coil plate 30 may have the upper end connected to the outer body 10 through the suspension 40 and the lower end connected to a damper 50 to vertically vibrate and transmit vibration to the vibration target through the suspension 40.

As described above, a vibration actuator having a structure in which the magnetic body 20 vibrates vertically or a structure in which the coil plate 30 vibrates vertically may be implemented depending on structures of (A) and (B) of FIG. 1.

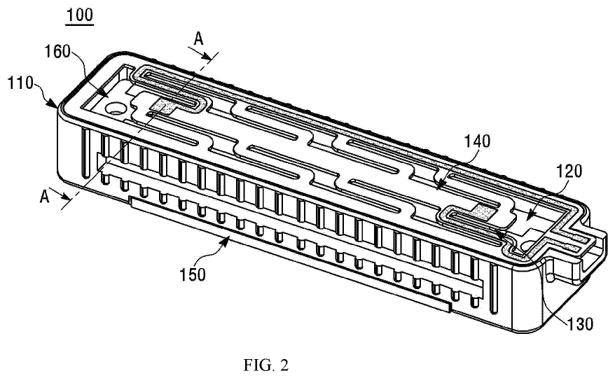

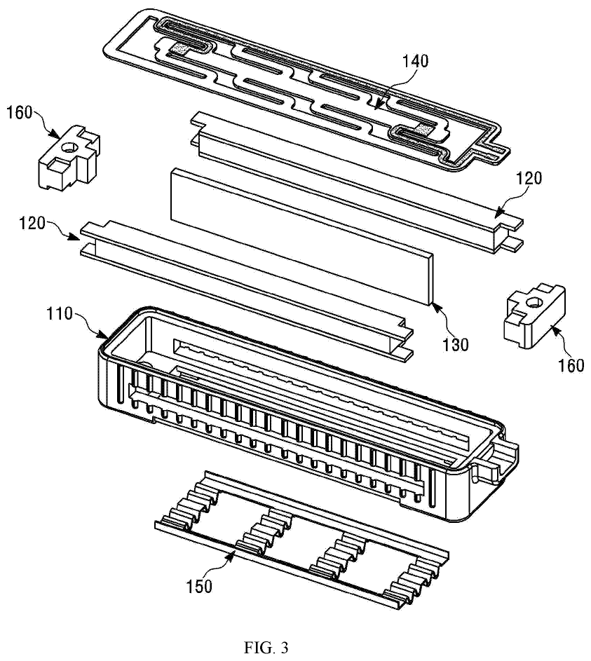

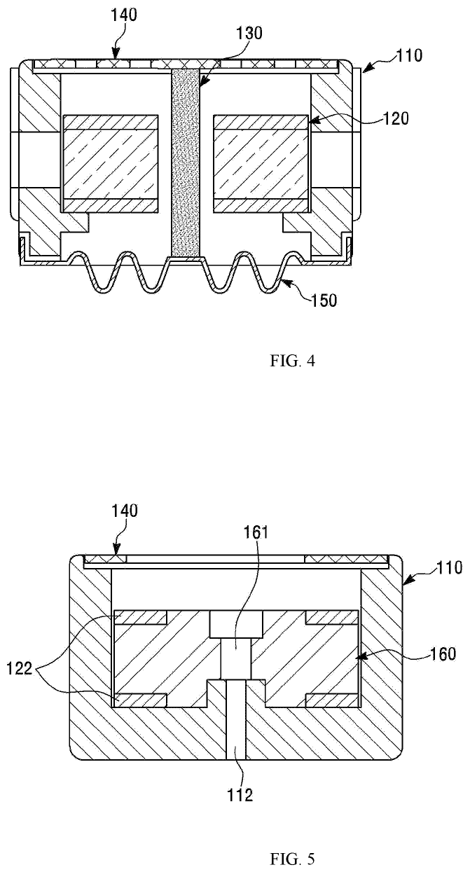

FIG. 2 is a perspective view illustrating the vibration actuator including a PCB plate with a lead wire and a suspension integrated according to an embodiment of the present invention, FIG. 3 is an exploded perspective view illustrating the vibration actuator including the PCB plate with the lead wire and the suspension integrated according to an embodiment of the present invention, FIG. 4 is a cross-sectional view taken along line A-A in FIG. 2, and FIG. 5 is a cross-sectional view taken along line B-B in FIG. 2.

As illustrated in FIGS. 2 to 5, a vibration actuator 100 according to an embodiment of the present invention may include a frame 110, a magnetic body 120, a coil plate 130, a PCB plate 140, a damper 150, and a guide 160.

The frame 110 may be manufactured by resin molding. The frame 110 may have a stick-type long rectangular shape with a box-shaped structure or a structure having top and bottom surfaces and columns at corners.

The frame 110 may be an outer housing of the vibration actuator 100.

A magnetic circuit unit including the magnetic body 120 and the coil plate 130 may be disposed at a center of the frame 110, the coil plate 130 may be disposed at a center of the magnetic circuit unit, and a pair of magnetic bodies 120, which are spaced by the same distance from each other, may be disposed at both sides of the coil plate 130, respectively.

Each of the magnetic bodies 120 may include a pair of magnets 121, which face each other, and pairs of yokes 122 attached to top and bottom surfaces of the pair of magnets 121.

An elongated vent hole 111 capable of dissipating heat generated by a magnetic circuit and a voice coil to the outside may be defined in each of both side surfaces of the frame 110.

A guide 160 may be fastened to both ends of the pair of magnetic bodies 120 so that the pair of magnetic bodies 120 are fixed to the frame 110.

The coil plate 130 may be a printed circuit board (PCB), and a conductive coil may be patterned in a track shape on the coil plate 130.

The coil plate 130 in a vertically oriented state has an upper end connected to the PCB plate 140 and a lower end attached and connected to a damper 150.

The damper 150 may have a wrinkled shape made of a fabric material or a wrinkled shape made of an elastic material. Alternatively, a metal suspension may be used as the damper.

A magnet may be disposed between the pair of magnetic bodies 120, and magnet plates (yokes) may be attached to top and bottom surfaces of the magnets, respectively.

The pair of magnetic bodies 120 may be fixed to the frame 110 in such a manner that both ends of each thereof are fastened to the guide 160 and inserted into left and right insertion grooves of the frame 110.

Referring to FIG. 5, the magnetic body 120 including the magnet 121 and the yoke 122 may be inserted to the guide 160 and fastened to a tab 112 disposed at a lower end of the frame 110 through a fastening hole 161 defined at a central portion of the guide 160.

Here, the PCB plate 140 may include a lead wire formed thereon to apply external power to the coil plate 130 and have a suspension structure capable of transmitting a vertical vibration of the coil plate 130.

An operation of the above-described vibration actuator 100 will be described below.

An induced electromotive force is generated when a current flows through a moving coil patterned on the coil plate 130, and a vertical vibration force is generated to a magnetic field of N and S poles corresponding to the movable coil by the Fleming's left hand rule and the Lorentz force law.

Since the pair of magnetic bodies 120 disposed at left and right sides are fixed to the frame 110, the coil plate 130 of the magnetic circuit performs vertical vibration, and vertical vibration energy is transmitted to the vibration target through the frame 100 by using the suspension and the damper 50.

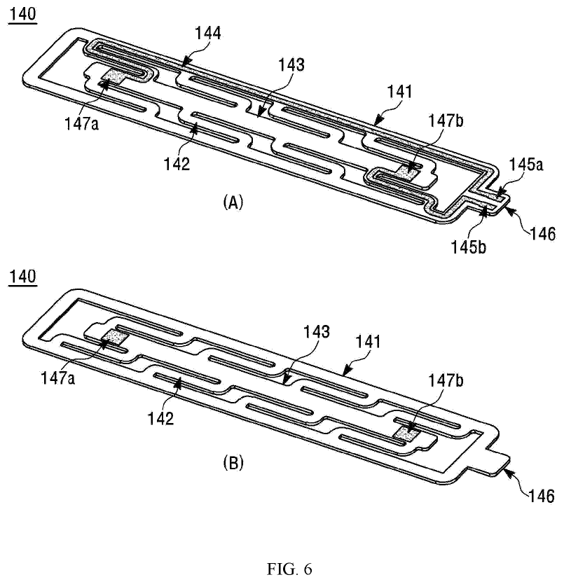

FIG. 6 is a perspective view illustrating the PCB plate of the vibration actuator including the PCB plate with the lead wire and the suspension integrated according to an embodiment of the present invention.

Referring to FIGS. 1 to 6, the vertical vibration energy of the vibration actuator 100 according to the present invention may be generated by the vertical vibration of the coil plate 130.

The coil plate 130 may have an upper end connected to the PCB plate 140 and a lower end connected to the damper 150 to implement a vertical vibration mechanism.

(A) of FIG. 6 is a perspective view illustrating one surface of the PCB plate 140, and (B) of FIG. 6 is a perspective view illustrating the other surface of the PCB plate 140.

The PCB plate 140 according to the present invention is newly suggested component to implement an ultra-slim vibration actuator.

The PCB plate 140 may be bonded to an upper end of the frame 110 and include a plurality of bridges 142 each having a suspension function capable of smoothly controlling the vertical vibration of the coil plate 130, external lead wire copper foils 145 and 145b for soldering connection with lead wires to allow external signal input, and coil plate copper foils 147a and 147b for soldering connection with the coil plate 130, thereby allowing the ultra-slim vibration actuator to be developed.

The PCB plate 140 may include an edge 141, a central plate 143 disposed at an inner center of the edge 141, a plurality of bridges 142 connecting the edge 141 and the central plate 143 to perform a suspension function, a lead wire 144 that allows a connection with an external power source, external lead wire copper foils 145 and 145b for soldering connection with external lead wires, a terminal block 146 formed with a pair of terminals at one end thereof for connecting the external lead wires, and coil plate copper foils 147a and 147b for soldering connection with a coil of the coil plate 130.

The bridges 142 may connect the edge 141 and the central plate 143 at both sides, each have a shape having at least one curved portion to apply a vibration force, and have the same number and the same shape on left and right sides (left and right sides based on the central plate 143) to maintain a vibration balance at the left and right sides.

One lead wire 144 may be connected to the copper foil 147a disposed at one end of the central plate 143 through the edge 141 and the bridge 142 from the external lead wire copper foil 145a disposed on the terminal block 146, and the other lead wire 144 may be connected to the copper foil 147b disposed at the other end of the central plate 143 through the edge 141 and the bridge 142 from the external lead wire copper foil 145b disposed on the terminal block 146.

The copper foils 147a and 147b representing lower ends of the PCB plate 140 in (B) of FIG. 6 may be soldered to positive (+) and negative (−) terminals of the coil plate 130 so that the PCB 140 is electrically and mechanically connected to the coil plate 130.

Thus, the coil plate copper foils 147a and 147b pass through the PCB plate 140 and are disposed at both sides of the central plate 143, respectively.

As described above, the vibration actuator 100 according to the present invention may apply the vibration energy to the vibration target through the PCB plate 140 with the lead wire and the suspension integrated and have the ultra-slim shape to satisfy a demand for miniaturization in various haptic device products.

Features, structures, and effects described in the above embodiments are incorporated into at least one embodiment of the present disclosure, but are not limited to only one embodiment. Moreover, features, structures, and effects exemplified in one embodiment may easily be combined and modified for another embodiment by those skilled in the art. Therefore, these combinations and modifications should be construed as falling within the scope of the present disclosure.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

[Description of reference numerals]

| | |
|---|---|
| 10: Outer body | 20, 120: Magnetic body |
| 30, 130: Coil plate | 40: Suspension |
| 50, 150: Damper | 60: Magnetic circuit unit |
| 110: Frame | 140: PCB plate |
| 160: Guide | |

1. A vibration actuator with a lead wire and a suspension integrated, the vibration actuator comprising:
a frame that forms an outer portion;
a pair of magnetic bodies that is spaced apart from each other in left and right directions and fixed to the inside of the frame;
a coil plate having a coil disposed between the pair of magnetic bodies;
a PCB plate disposed at an upper end of the coil plate; and
a damper disposed at a lower end of the coil plate,
wherein a plurality of bridges having a suspension function and a lead wire for connection to an external power supply are formed on the PCB plate.

2. The vibration actuator of claim 1, wherein the PCB plate comprises an edge, a central plate disposed at an inner center of the edge, and a plurality of bridges configured to connect the edge and the central plate.

3. The vibration actuator of claim 2, wherein the PCB plate comprises the lead wire having one end on which an external lead wire copper foil for soldering connection with an external lead wire is formed and the other end on which a coil plate copper foil for soldering connection with a coil of the coil plate is formed,
a terminal block is further formed at one end of the PCB plate,
the external lead wire copper foil is formed on the terminal block, and
the coil plate copper foil is formed on each of one end and the other end of the central plate.

4. The vibration actuator of claim 3, wherein the coil plate copper foil passes through the central plate and is formed on each of top and bottom surfaces of the central plate.

5. The vibration actuator of claim 2, wherein the bridges each have a shape having at least one curved portion and have the same number and the same shape on left and right sides based on the central plate.

6. The vibration actuator of claim 1, wherein the PCB plate comprises the lead wire having one end on which an external lead wire copper foil for soldering connection with an external lead wire is formed and the other end on which a coil plate copper foil for soldering connection with a coil of the coil plate.

7. The vibration actuator of claim 6, wherein a terminal block is further formed at one end of the PCB plate,
the external lead wire copper foil is formed on the terminal block, and
the coil plate copper foil is formed at a position corresponding to the coil plate disposed at a lower end of the PCB plate.

8. The vibration actuator of claim 1, wherein each of both ends of the pair of magnetic bodies is coupled to the guide, and
the guide is fastened to the frame by a bolt through a through-hole.

9. The vibration actuator of claim 1, wherein a vent hole through which heat of the coil plate, which is generated by an operation of a magnetic circuit in the coil plate, is discharged to the outside is formed in each of both side surfaces of the frame.
